(19) United States
(12) Patent Application Publication
(10) Pub. No.: US 2005/0175155 A1
(43) Pub. Date: Aug. 11, 2005

(54) Mammography film cassette

(75) Inventors: William C. Wendlandt, Rush, NY (US); David E. Foeller, Batavia, NY (US)

Correspondence Address: Pamela R. Crocker;Patent Legal Staff, Eastman Kodak Company, 343 State Street, Rochester, NY, 14650-2201, US

(73) Assignee: Eastman Kodak Company

(21) Appl. No.: 10/776,833

(22) Filed: Feb. 11, 2004

(51) Int. Cl. G03B 42/04

(52) U.S. Cl. 378/182

(57) ABSTRACT

A durable x-ray film cassette particularly suited for mammography. The cassette includes a premolded tubeside and screenside panels encased in secondary molding process into a molded framework in which the screenside panel and the tubeside panel are joined by an integrally molded living hinge molded to the top edge of an upstanding back wall of the tubeside panel to allow close positioning of the X-ray film to the patient's chest wall. Relative movement between the closed screenside and tubeside panels is suppressed by means of a locating feature including a locating tab and a locating notch formed in at least one pair of facing framework lateral side segments.

### FIELD OF THE INVENTION

This invention relates to the field of x-ray imaging, and more particularly to x-ray film mammography cassettes.

### BACKGROUND OF THE INVENTION

A currently available X-ray film mammography cassette known as the Min-R 2 cassette is made by Eastman Kodak Company, assignee of the present invention. This cassette employs an X-ray transparent polycarbonate panel with peripheral walls that define the film compartment. The front and side walls are inset from the outer edges of the panel and additionally serve to form a light tight seal with mating elements of the cassette cover. The rear wall, also referred to as the chest wall, extends upward along the rearmost extremity of the panel so as to allow the film to be positioned as close as possible to the patient's chest. This panel is generally referred to as the tubeside panel.

The cassette cover, or screenside panel, supports an intensifying screen that fluoresces in response to X-ray bombardment which enhances the quality of the resultant film image. The cover is joined to the tubeside panel by means of a separate plastic snap-fit hinge that extends the length of the chest wall. The hinge is snapped into place along the top edge of the chest wall so as not to interfere with placement of the cassette chest wall against the patient's chest. In addition, the placement of the hinge at the top of the chest wall preserves the uniformity of the x-rays coming through the tubeside panel to the screen.

One difficulty encountered with this arrangement is that the durability of the cassette may be compromised by the snap fit hinge, under certain handling conditions. Mammography cassettes are typically subject to careful handling during normal usage, but may at times be subjected to rougher treatment such as dropping onto the floor, harsh insertion into holders and stacking for storage purposes. Over time the hinge may become loose and can separate from the cover. Furthermore, the lack of long term hinge stability may cause relative movement between the cover and tubeside panel which may result in degradation of the resultant image. Thus, there is a need for improvement of this basic design of cassette to enhance its durability so as to withstand the rough handling sometimes encountered.

In U.S. Pat. No. 3,504,180, entitled “X-ray Film Package”, issued Mar. 31, 1970, and assigned to the assignee of the present invention and incorporated herein by reference, an X-ray film cassette is disclosed, the teachings of which are embodied in an X-ray cassette made and sold by the present assignee under the name X-Omat X-ray cassette. The cassette employs aluminum screenside and tubeside panels set into molded polyurethane frames. The sides of the frames are molded to the edges of the panels, extending outwardly therefrom. The backs of the two frames are joined by an integrally molded hinge structure extending well beyond the rear extremities of the two panels making such an arrangement unsuitable for use in a mammography cassette.

Accordingly, there is a need for an improved mammography film cassette that offers improved durability while at the same time enabling the film to be positioned as close to the chest wall as possible.

### SUMMARY OF THE INVENTION

In accordance with the invention therefore, there is provided a durable mammography cassette which comprises primary molded screenside and tubeside plastic panels, each of said panels having a front side, a pair of lateral sides and a back side. The back side of the tubeside panel forms an integrally molded upstanding back wall terminating in a top edge. The cassette includes a secondary molded framework comprised of first and second frames. Each of the frames has border segments molded, respectively, to at least the lateral and back sides of each of the screenside and tubeside panels with the back side border segment of the tubeside panel being molded to the top edge of the back wall. The framework further includes an integrally molded living hinge segment joining the back side border segment of the screenside panel to the back side border segment of the tubeside panel along the top edge of the back wall.

Any objects are given only by way of illustrative example, and such objects may be exemplary of one or more embodiments of the invention. Other desirable objectives and advantages inherently achieved by the disclosed invention may occur or become apparent to those skilled in the art. The invention is defined by the appended claims.

### BRIEF DESCRIPTION OF THE DRAWINGS

The foregoing and other objects, features, and advantages of the invention will be apparent from the following more particular description of the preferred embodiments of the invention, as illustrated in the accompanying drawings.

FIG. 1A is a perspective view of a mammography cassette in the open position constructed in accordance with the invention.

FIG. 1B is an enlarged section of the hinged backside of the cassette of FIG. 1A.

FIG. 2 is an expanded perspective view of a portion of the back side of the cassette of FIG. 1A showing the hinge segment in greater detail.

FIG. 3 is an enlarged sectional view similar to FIG. 1B illustrating further details of the hinged segment of the FIG. 1A cassette.

FIG. 4 is an exterior perspective view of a portion of the hinge segment of the FIG. 1A cassette, except in a substantially closed position.

FIG. 5 is a perspective view of portion of a cassette of the invention illustrating another aspect of the invention.

FIG. 6 is a diagrammatic illustration useful in explaining the aspect of the invention shown in FIG. 5.

### DETAILED DESCRIPTION OF THE INVENTION

The following is a detailed description of the preferred embodiments of the invention, reference being made to the drawings in which the same reference numerals identify the same elements of structure in each of the several figures.

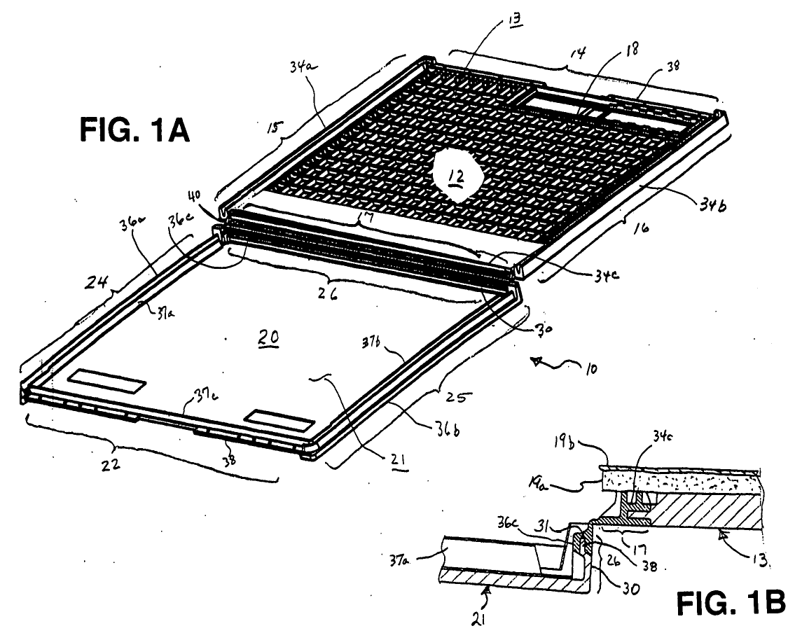

Referring to FIGS. 1A and 1B, there are shown therein perspective views of a mammography cassette 10 which includes a first panel 12 having a front side 14, lateral sides 15, 16 and a back side 17. This panel, hereinafter referred to as the screenside panel is injection molded in a primary mold of a thermoplastic material, such as polycarbonate with an integral grid structure 18 formed on the inner surface of the panel to impart lightweight rigidity to the panel as well as to provide an appropriately spaced surface for adhesively mounting thereon a foam layer 19a and an intensifying screen 19b as shown in FIG. 1B. The details of this grid mounting arrangement are well known in the aforementioned Min-R 2 cassette and need not be described further. Cassette 10 further includes a second panel 20 similarly having a front side 22, lateral sides 24, 25 and a back side 26. This panel, referred herein as the tubeside panel, is comprised of a slightly cylindrically curved surface injection molded in a primary mold and consists of an X-ray transparent thermoplastic material, such as polycarbonate. As in the Min-R 2 cassette, this cylindrical curvature, with the axis of the cylinder parallel to the back wall of the panel, is for the purpose of enhancing contact of the X-ray film loaded on the tubeside panel 20 against intensifying screen 19b when the cassette is closed. Inwardly spaced upstanding walls 37a, b and c are integrally molded on panel sheet 20 adjacent front and lateral sides 22, 24 and 25 to define a film compartment which receives X-ray film loaded into the cassette. Back side 26 of panel sheet 21 is formed with an integrally molded upstanding back wall 30, sometimes referred to as the chest wall, and which terminates in a top edge 31. The back wall 30 extends substantially the length of the back side 26 of panel 20.

Cassette 10 further includes a unitary framework molded, in a secondary molding process, around the sides of each of the screenside and tubeside panels, the frames being joined at the back of the cassette by a living hinge integrally molded with the frames. More specifically, the framework comprises a first frame having at least three border segments 34a, 34b and 34c molded respectively to the lateral and back side edges of screenside panel 13. The framework also includes a frame having at least three border segments 36a, 36b, and 36c molded respectively to the lateral and back side edges of tubeside panel 20. With one exception, the border segments of both panels are molded to outwardly facing edges of the panels. However, in accordance with a feature of the invention, border segment 36c is molded to the upwardly facing top edge 31 of back wall 30. The front sides of the panels may include L-shaped metal strips 38 that provide sufficient rigidity and ruggedness as to not require molded border segments as part of the frames. Framework 32 further includes an integrally molded living hinge segment 40 which joins the back side border segment 34c of screenside frame 34 to the back side border segment 36c at the top edge 31 of back wall 30. The unitary hinge extends the length of the respective border segments. This arrangement combines the ruggedness and durability of molded frames with an integrally molded hinge as found in the aforementioned X-Omat cassette but also permits the back wall of the cassette to be placed directly against the chest of the patient, as in the case of the Min-R 2 cassette. As best seen in FIG. 1B, back wall 30 is formed with a forwardly offset segment 38 leading to the top edge 31 leaving a resultant trough beneath the offset segment 38 to accept the edge of the film and screen against backwall 30. The amount of offset is such that the rear external surface of backside segment 36c molded onto top edge 31 is at or forward of the rear external surface of back wall 30. This ensures that the film in the cassette is effectively held against the patient's chest wall without interference from the molded frame segment 36c. An additional advantage of this offset in the backwall is that the backside segment 36c is readily molded to the top edge 31 without requiring any undercuts in the mold process.

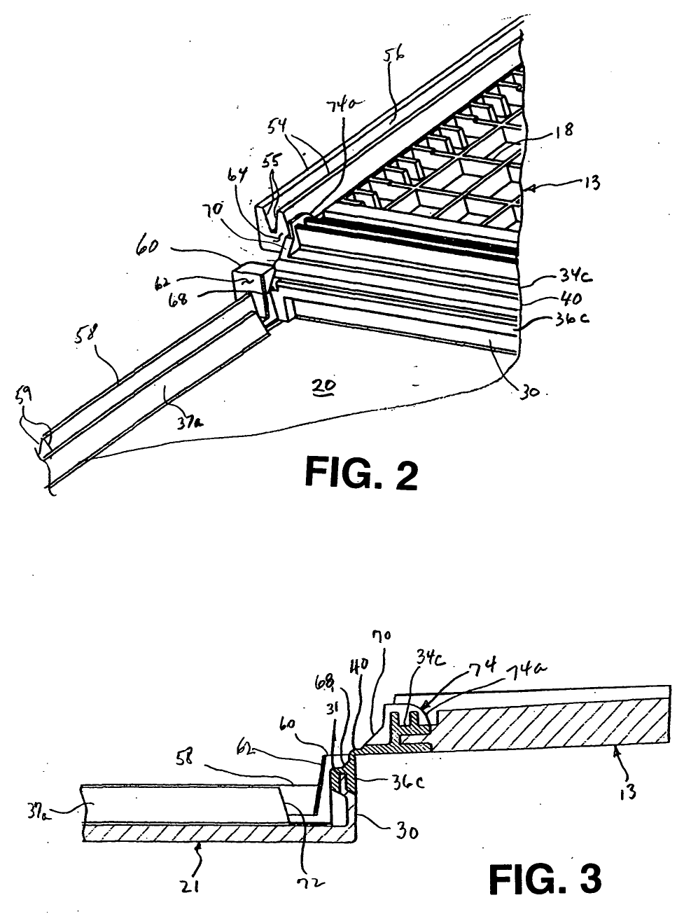

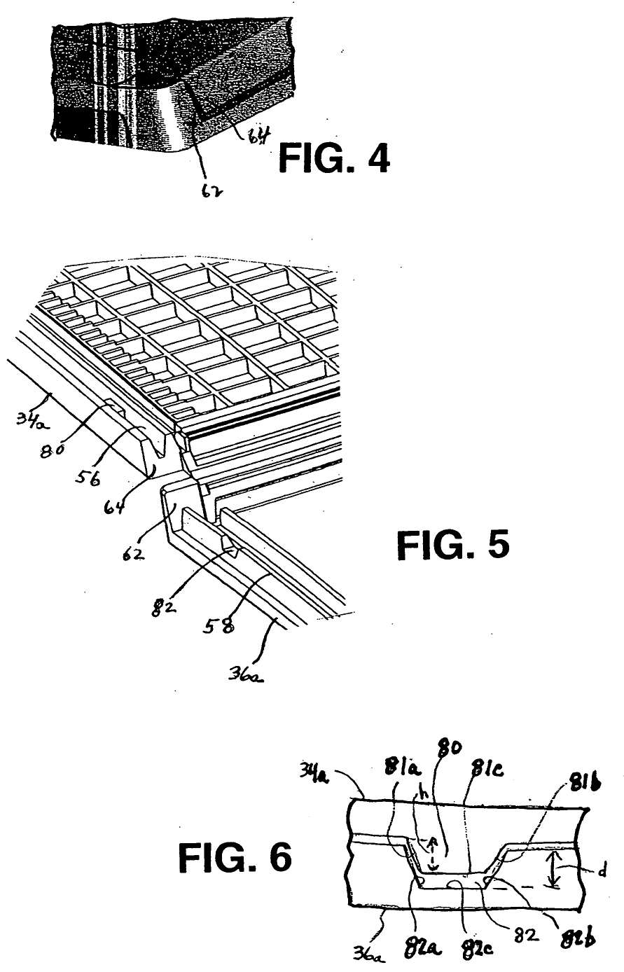

The lateral border segments of the molded frame are molded/shaped to provide light seals to prevent exposure of the X-ray film in the compartment. Referring now to FIG. 2, screenside border segment 34a is provided with longitudinally extending parallel ridges 54 having slanted inner surfaces 55 forming a groove 56 therebetween. Border segment 34a is formed with a longitudinally extending, centrally positioned ridge 58 having slanted sides 59 adapted to mate with groove 56 thereby providing a labyrinth light path that prevents exposure of the film in the cassette. This arrangement serves the additional benefit of enhancing the stability and durability of the cassette by aiding in the resisting of lateral movement or twisting effect between the screenside and tubeside panels. Lateral ridge 58 terminates at the rear of the cassette at an upstanding integrally molded corner post 60, of generally rectangular cross section. Forward face 62 of the post is slanted such that the top of the post in the lateral direction of the cassette is slightly shorter than the base. The grooved ridges 54 terminate in a correspondingly slanted end face 64 at a point short of the back corner between border segment 34a and border segment 34c so that, as illustrated in FIG. 4, when the screenside panel is closed down onto the tubeside panel, end face 64 folds over post 60 and mates with face 62 of post 60 to provide positive positioning of the screenside panel, in the back to front direction, over the tubeside panel. The same structure as just described is also used on the opposite lateral side segments 34b and 36b.

Referring jointly to FIGS. 2 and 3, a slanted slot 68 is formed in each end of the backside border segment 36c at the point of juncture with the respective corner post 60. A projecting slanted ridge 70 is formed at each end of backside segment 34c, and is shaped to mate with slanted slot 68 upon closure of the cassette to form a light shield at each end of the backside segments 34c and 36c. The interior film compartment sidewall 37a terminates with a slanted end surface 72 at a point short of backside segment 36c to form a recess adjacent hinge 40. The compartment wall 37b is similarly formed. A cam tab 74 is formed at each end of backside segment 34c with a camming surface 74a that interacts with mating surface 72 upon closure of the cassette. The effect is to positively align edges of the intensifying screen and film along the tubeside back wall by forcing the intensifying screen against the chestwall, where the film has already been located prior.

Referring now to FIG. 5, in a further aspect of the invention, the molded framework includes an arrangement to positively locate the screenside and tubeside panels relative to each other so as to eliminate relative movement and consequent shifting of the screen relative to the chestwall after the cassette is closed. To this end, the framework includes a locating rib 80 integrally molded in the groove 56 of border segment 34a. At the same relative position in border segment 36a, a locating notch 82 is molded into the ridge 58 of border segment 36a. Referring to FIG. 6, the side cross section of the locating rib 80 is in the form of a truncated pyramid with sloping end surfaces 81a, 81b and top surface 81c while the notch 82 is in the mating inverse form with sloping surfaces 82a, 82b and bottom surface 82c. By design, the height h of locating rib 80 is shorter than the depth d of notch 82. This arrangement assures that the two panels are positively locked and located relative to each other, ensuring that the screen is held in intimate contact with the chest wall during handling and screening of the patient.

It can be seen from the foregoing description that the X-ray film mammography cassette disclosed herein advantageously provides a highly durable, all plastic construction that will withstand rough handling in normal use and has the benefit of low cost production using relatively simple molding techniques.

The invention has been described in detail with particular reference to a presently preferred embodiment, but it will be understood that variations and modifications can be effected within the spirit and scope of the invention. The presently disclosed embodiments are therefore considered in all respects to be illustrative and not restrictive. The scope of the invention is indicated by the appended claims, and all changes that come within the meaning and range of equivalents thereof are intended to be embraced therein.

### PARTS LIST

10 mammography cassette
12 screenside panel
13 panel sheet
14 front side of panel 12
15,16 lateral sides of panel 12
17 backside of panel 12
18 grid structure
19a foam layer
19b intensifying screen
20 tubeside panel
21 panel sheet
22 front side of panel 20
24, 25 lateral sides of panel 20
26 back side of panel 20
30 backwall of panel 20
31 top edge of back wall 30
32 framework
34a,b,c border segments of frame 34
36a,b,c border segments of frame 36
37a,b,c film compartment walls
38 metal strips
40 living hinge
54 parallel ridges
55 ridge inner slanted surfaces
56 groove
58 ridge
59 ridge slanted sides
60 corner post
62 corner post slanted surface
64 end face of ridges 54
68 slanted slot
70 slanted ridge
72 slanted end surface
74 cam tab
74a camming surface
80 locating tab
81a,b,c tab surfaces
82a,b,c notch surfaces

1. An x-ray film cassette comprising:
a primary molded screenside and tubeside plastic panels, each of said panels having a front side, a pair of lateral sides and a back side, the back side of the tubeside panel forming an integrally molded upstanding back wall terminating in a top edge; and
a secondary molded framework comprising first and second frames, each of said frames having border segments molded, respectively, to at least the lateral and back sides of each of the screenside and tubeside panels, the back side border segment of the tubeside panel being molded to the top edge of said back wall, said framework including an integrally molded living hinge segment joining the back side border segment of the screenside panel to the back side border segment of the tubeside panel along the top edge of said back wall.

2. The cassette of claim 1, further including a resilient layer secured to the inside face of the screenside panel and an intensifying screen secured to face of the resilient layer such that upon closure of the screenside panel, with film loaded in the cassette, the intensifying screen comes into uniform surface contact with the film and also aligns itself to the film at the chest wall of the tubeside panel.

3. The cassette of claim 1, wherein said backwall has a rear external surface and said top edge is offset forwardly of said back wall rear external surface and said back side border segment of the tubeside panel is molded on said top edge with a rear external surface that is at or forward of the rear external surface of the tube side back wall.

4. The cassette of claim 1, wherein the lateral and backside border segments of the tubeside panel terminate in a pair of upstanding generally rectangular integrally molded corner posts;
the backside border segment of the tubeside panel having slanted slots formed at each end thereof at the respective points of juncture with the upstanding corner posts; and
the backside border segment of the screenside panel having projecting ridges formed at opposite ends thereof adapted to mate with said grooves upon closure of the panels such that a light tight seal is thereby formed at each end of said hinge to prevent unwanted exposure of film loaded into the cassette.

5. The cassette of claim 1, wherein said tubeside panel includes upstanding side walls defining a film compartment, the side walls each having a recess formed at the back thereof adjacent said hinge, the cassette further including a cam tab on the backside border segment of the screenside panel and positioned such that, upon closure, the cam tabs interact with mating surfaces of the recesses to positively align rear edge of the intensifying screen along the tubeside back wall, thereby bringing it into alignment with the film already at the same location.

6. The cassette of claim 1, wherein said lateral border segments are shaped in cross section to provide a labyrinth light shield along lateral sides of the cassette.

7. The cassette of claim 6, wherein each pair of facing lateral border segments comprise a pair of elongated ridges forming a groove therebetween on one of the border segments and an elongated mating ridge positioned on the on the other of said facing segments to fit the said groove so as to create said labyrinth light shield.

8. The cassette of claim 1, including a locating feature comprising a locating tab formed on at least one of said lateral side segments and a mating locating notch formed in a lateral side segment facing said locating tab.

9. The cassette of claim 8, wherein said locating tab, in cross section, has a truncated pyramid shape and said locating notch has mating sloping edge surfaces to engage corresponding sloping side surfaces of said locating tab.

10. The cassette of claim 9, wherein said locating tab has a predetermined height and said locating notch has a predetermined depth, said height being shorter than said depth.

11. The cassette of claim 7, further including a locating feature comprising a locating tab formed in said groove and a mating locating notch formed in said elongated mating ridge

12. The cassette of claim 1 1, wherein said locating tab, in cross section, has a truncated pyramid shape and said locating notch has mating sloping edge surfaces to engage corresponding sloping side surfaces of said locating tab.

13. The cassette of claim 12, wherein said locating tab has a predetermined height and said locating notch has a predetermined depth, said height being shorter than said depth.

14. The cassette of claim 1, wherein said panels are comprised of a thermoplastic material and said molded framework comprises a thermoset material.

15. The cassette of claim 14, wherein said thermoplastic material is polycarbonate and said thermoset material is polyurethane.
